(19) United States
(12) Patent Application Publication
(10) Pub. No.: US 2003/0020332 A1
(43) Pub. Date: Jan. 30, 2003

(54) Dual energy coupling device

(75) Inventors: Demetri Giannopoulos, Norwalk, CT (US); Willem G. Odendaal, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/916,955

(22) Filed: Jul. 27, 2001

(51) Int. Cl. H02J 4/00

(52) U.S. Cl. 307/18

(57) ABSTRACT

A dual energy coupling device involving the transfer of magnetic energy and electric energy between a pair of electric conductors is disclosed. The transfer of magnetic energy establishes an inductive coupling of a power source and a load of the device whereby an electric signal as a power signal or an indication of information can be communicated between inductively coupled power source and load. The transfer of electric energy facilitates an establishment of a capacitive coupling of another power source and another load of the device whereby an electric signal as part of a power signal or an indication of information can be communicated between the capacitively coupled power source and load.

### BACKGROUND OF THE INVENTION

1. Field of the Invention

The present invention generally relates to a contactless energy transfer for low power applications. The present invention specifically relates to a simultaneous transfer of magnetic energy and electric energy for low power applications.

2. Description of the Related Art

Inductive coupling typically involves an employment of a source coil within a source circuit and a load coil within a load circuit. The source coil generates a magnetic field when a source current signal flows through the source coil, and a load current signal flows through the load coil when any magnetic flux of the magnetic field cuts across the load coil. Accordingly, the transfer of magnetic energy from the source coil to the load coil inductively couples the source circuit and the load circuit. Currently, inductive coupling is utilized in contactless power transfers. For example, inductive coupling has been utilized for non-intrusive recharging of pacemaker batteries. Additionally, inductive coupling has been utilized for recharging of various vehicle batteries.

Capacitive coupling typically involves an employment of some of form of capacitor having a source electric conductor within a source circuit and a load electric conductor within a load circuit. An electric field is generated between the electric conductor when a source voltage signal is applied to the first element, and a load voltage signal is applied to the load electric conductor when the electric flux of the electric field flows to the load electric conductor. Accordingly, the transfer of electric energy from the source electric conductor to the load electric conductor capacitively couples the source circuit and the load circuit. Currently, capacitive coupling is also utilized in contactless power transfers. For example, capacitive coupling has been utilized in security systems including personal identity badges.

The present invention is an improvement over the current utilization of inductive coupling and capacitive coupling for recharging of systems.

### SUMMARY OF THE INVENTION

The present invention relates to a dual energy coupling device. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a dual energy coupling device comprising a first electric conductor and a second electric conductor. The first electric conductor is operable to provide a magnetic energy and an electric energy across an interface to the second electric conductor in response to a reception of an electric signal.

A second form of the present invention is a dual energy coupling device comprising a power source, a first electric conductor and a second electric conductor. The power source is operable to provide an electric signal. The first electric conductor is in electrical communication with said first power source to thereby receive the electric signal when said first power source is providing the electric signal. The first electric conductor is operable to transfer a magnetic energy and an electric energy across an interface to the second electric conductor in response to a reception of the electric signal.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a block diagram of a first structural embodiment of a dual energy coupling device in accordance with the present invention;

FIG. 2A illustrates a top view of a schematic diagram of a first configurational embodiment of a pair of electric conductors of the FIG. 1 device;

FIG. 2B illustrates a side view of the FIG. 2A electric conductors;

FIG. 3A illustrates a top view of a schematic diagram of a second configurational embodiment of a pair of electric conductors of the FIG. 1 device;

FIG. 3B illustrates a side view of the FIG. 3A electric conductors;

FIG. 4A illustrates a cross-sectional side view of a first configurational embodiment of the FIGS. 3A and 3B substrates;

FIG. 4B illustrates a cross-sectional side view of a second configurational embodiment of the FIGS. 3A and 3B substrates;

FIG. 4C illustrates a cross-sectional side view of a third configurational embodiment of the FIGS. 3A and 3B substrates;

FIG. 4D illustrates a cross-sectional side view of a fourth configurational embodiment of the FIGS. 3A and 3B substrates;

FIG. 4E illustrates a cross-sectional side view of a fifth configurational embodiment of the FIGS. 3A and 3B substrates;

FIG. 5 illustrates a schematic diagram of a functional equivalent of a pair of electric conductors of the FIG. 1 device;

FIG. 6 illustrates a block diagram of a second structural embodiment of a dual energy coupling device in accordance with the present invention;

FIG. 7 illustrates a block diagram of a third structural embodiment of a dual energy coupling device in accordance with the present invention;

FIG. 8A illustrates a block diagram of a fourth structural embodiment of a dual energy coupling device in accordance with the present invention;

FIG. 8B illustrates a cross-sectional side view of a pair of FIG. 8A electric conductors formed on a substrate;

FIG. 9A illustrates a cellular phone and a battery recharger employing the FIG. 6 device;

FIG. 9B illustrates a rechargeable cellular phone employing the FIG. 1 device;

FIG. 9C illustrates a security reader and a security badge employing the FIG. 7 device; and

FIG. 9D illustrates a pacemaker and a battery recharger employing the FIG. 6 device.

### DETAILED DESCRIPTION OF THE PRESENTLY PREFERRED EMBODIMENTS

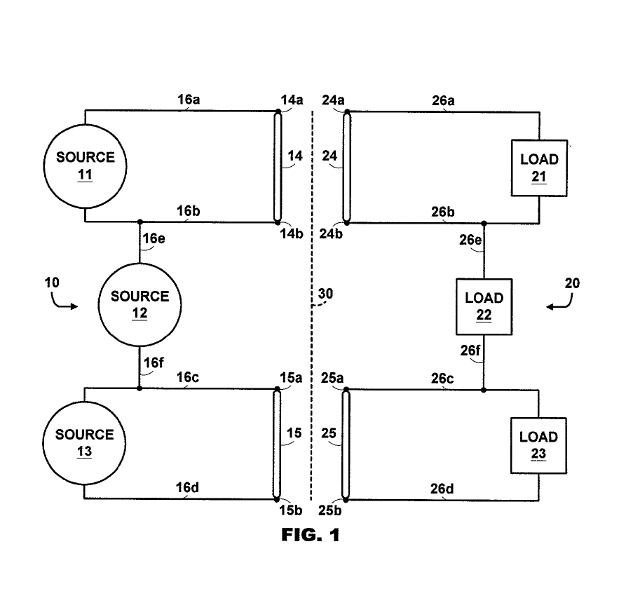

A dual energy coupling device of the present invention is illustrated in FIG. 1. The device comprises a source circuit 10 and a load circuit 20 spaced relative to an interface 30 (i.e., a mid-point of a gap between source circuit 10 and load circuit 20 when source circuit 10 and load circuit 20 are interacting). Source circuit 10 includes a power source 11, a power source 12, and a power source 13. Some examples of power sources 11-13 include a voltage source of any form, a current source of any form, and other sources as would occur to those having ordinary skill in the art. Source circuit 10 further includes an electric conductor 14 having a lead 14a and a lead 14b, and an electric conductor 15 having a lead 15a and a lead 15b. Electric conductor 14 is in electrical communication with power source 11 by an electric coupling of power source 11 to lead 14a and lead 14b via a conductor 16a and a conductor 16b, respectively. Electric conductor 15 is in electrical communication with power source 13 by an electric coupling of power source 13 to lead 15a and lead 15b via a conductor 16c and a conductor 16d, respectively. Electric conductor 14 is in electrical communication with power source 12 by an electric coupling of power source 12 to lead 14b via conductor 16b and a conductor 16e. Electric conductor 15 is in electrical communication with power source 12 by an electric coupling of power source 12 to lead 15a via conductor 16c and a conductor 16f. Other forms of coupling conductor 14 to source 11 and/or source 12 as would occur to those having ordinary skill in the art may be utilized in alternative embodiments of the present inventions. Also, other forms of coupling conductor 15 to source 12 and/or source 13 as would occur to those having ordinary skill in the art may be utilized in alternative embodiments of the present inventions. Additionally, power source 12 can be coupled to lead 14a and/or lead 15b in modified versions of source circuit 10.

Load circuit 20 includes a load 21, a load 22, and a load 23. Some examples of loads 21-23 include an impedance load, a capacitive load, an inductive load, a rectifier, an active load, a passive load, and other loads as would occur to those having ordinary skill in the art. Load circuit 20 further includes an electric conductor 24 having a lead 24a and a lead 24b, and an electric conductor 25 having a lead 25a and a lead 25b. Electric conductor 24 is in electrical communication with load 21 by an electric coupling of load 21 to lead 24a and lead 24b via a conductor 26a and a conductor 26b, respectively. Electric conductor 25 is in electrical communication with load 23 by an electric coupling of load 23 to lead 25a and lead 25b via a conductor 26c and a conductor 26d, respectively. Electric conductor 24 is in electrical communication with load 22 by an electric coupling of load 22 to lead 24b via conductor 26b and a conductor 26e. Electric conductor 25 is in electrical communication with load 22 by an electric coupling of load 22 to lead 25a via conductor 26c and a conductor 26f. Other forms of coupling conductor 24 to source 21 and/or source 22 as would occur to those having ordinary skill in the art may be utilized in alternative embodiments of the present inventions. Also, other forms of coupling conductor 25 to source 22 and/or source 23 as would occur to those having ordinary skill in the art may be utilized in alternative embodiments of the present inventions. Additionally, load 22 is coupled to lead 24a and/or lead 25b in modified versions of source circuit 20.

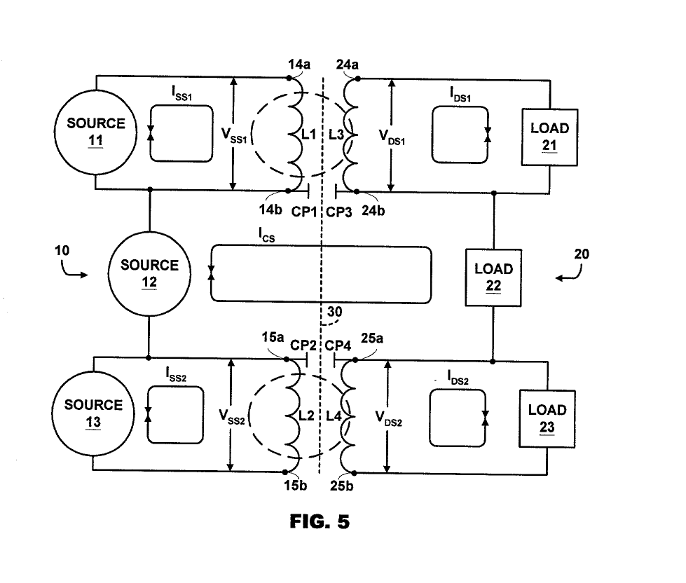

As will be subsequently described in more detail herein in connection with FIG. 5, electric conductor 14 transfers magnetic energy and electric energy across interface 30 to electric conductor 24 when power source 11 provides an electric signal to electric conductor 14. Additionally, electric conductor 15 transfers magnetic energy and electric energy across interface 30 to electric conductor 25 when power source 13 provides an electric signal to electric conductor 15. The result is a communication of an electric signal as a power signal or an indication of information between power source 11 and load 21, a communication of an electric signal as a power signal or an indication of information between power source 12 and load 22, and a communication of an electric signal as a power signal or an indication of information between power source 13 and load 23.

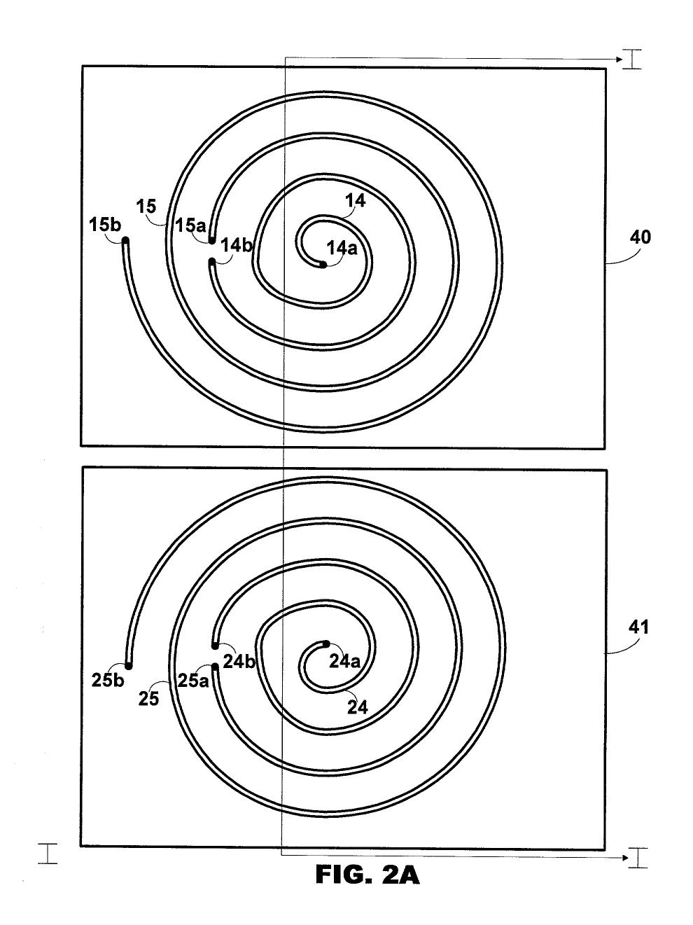

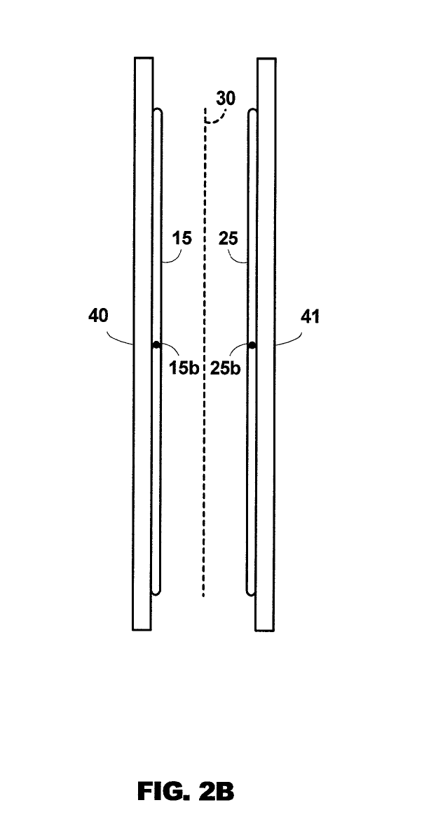

FIG. 2A illustrates one embodiment of spiral configurations of electric conductor 14 and electric conductor 15 as formed upon a substrate 40 (e.g., a printed circuit board). FIG. 2A also illustrates one embodiment of spiral configurations of electric conductor 24 and electric conductor 25 as formed upon a substrate 41 (e.g., a printed circuit board). As illustrated in FIG. 2B, the spiral configurations of electric conductor 14 and electric conductor 24 are congruent (i.e., coinciding when superimposed within the same plane) whereby electric conductor 14 and electric conductor 24 are symmetric relative to interface 30 to thereby facilitate the aforementioned energy transfers therebetween. FIG. 2B also illustrates the spiral configurations of electric conductor 15 and electric conductor 25 are congruent whereby electric conductor 15 and electric conductor 25 are symmetric relative to interface 30 to thereby facilitate the aforementioned energy transfers therebetween.

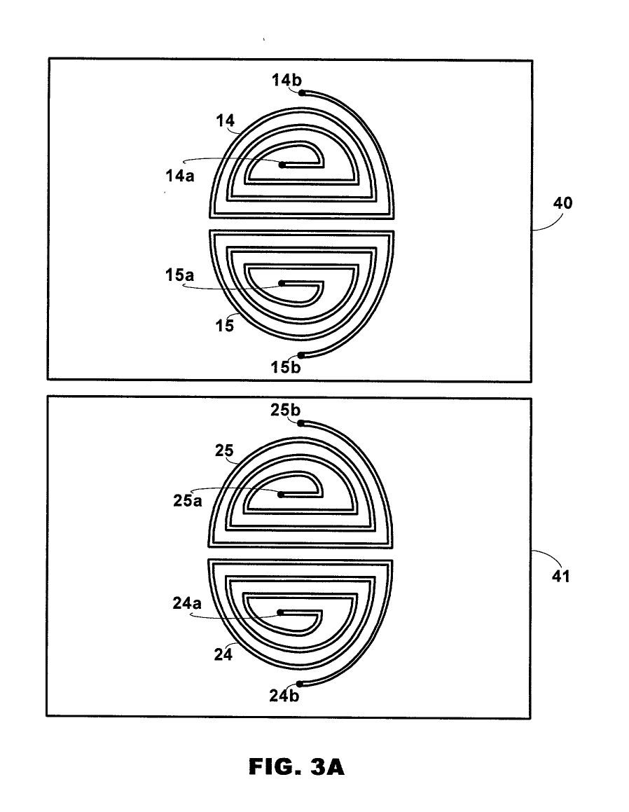

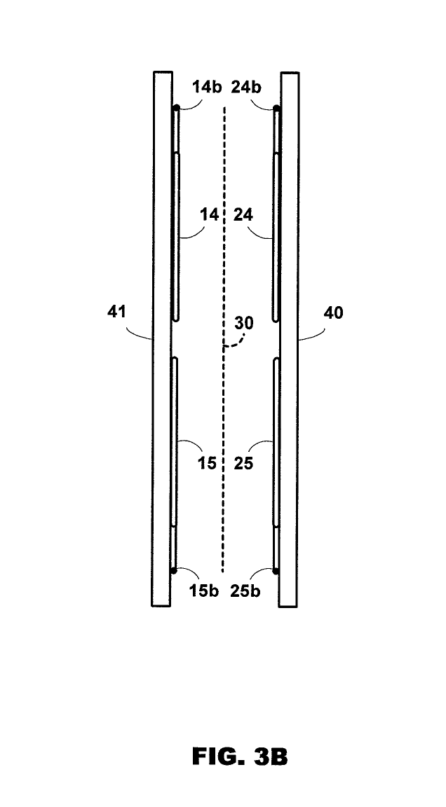

FIG. 3A illustrates another embodiment of spiral configurations of electric conductor 14 and electric conductor 15 as formed upon substrate 40. FIG. 3A also illustrates another embodiment of spiral configurations of electric conductor 24 and electric conductor 25 as formed upon substrate 41. As illustrated in FIG. 3B, the spiral configurations of electric conductor 14 and electric conductor 24 are congruent whereby electric conductor 14 and electric conductor 24 are symmetric relative to interface 30 to thereby facilitate the aforementioned energy transfers therebetween. FIG. 3B also illustrates the spiral configurations of electric conductor 15 and electric conductor 25 are congruent whereby electric conductor 15 and electric conductor 25 are symmetric relative to interface 30 to thereby facilitate the aforementioned energy transfers therebetween.

To enhance the transfer of electric energy between electric conductor 14 and electric conductor 24 as well as the transfer of electric energy between electric conductor 15 and electric conductor 25, a dielectric (e.g., a ceramic, a polymer composite, etc.) can be disposed between electric conductor 14 and electric conductor 24 as well as between electric conductor 15 and electric conductor 25. Alternatively or concurrently, the surfaces of electric conductor 14 and electric conductor 24 facing interface 30 are corrugated whereby interface 30 is corrugated therebetween to enhance the transfer of electric energy from electric conductor 14 to electric conductor 24 as well as the transfer of electric energy from electric conductor 15 to electric conductor 25.

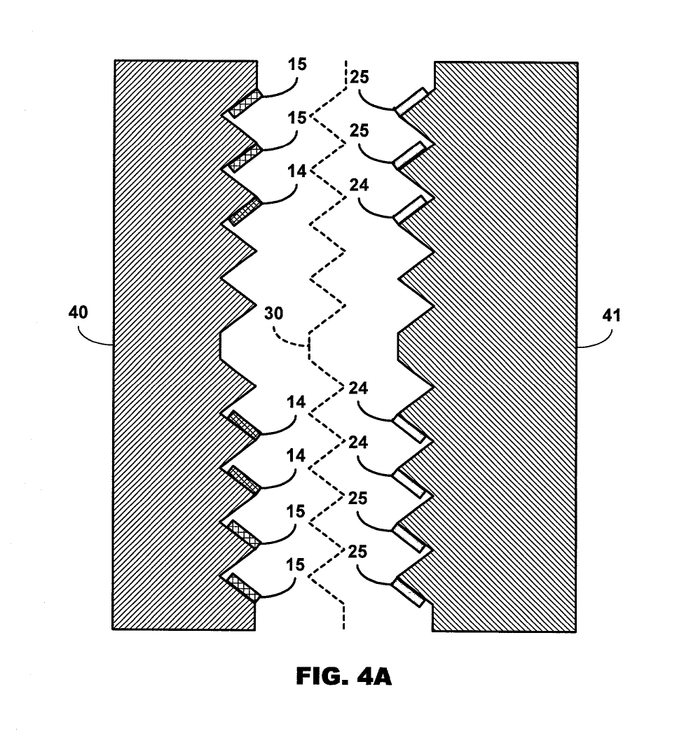

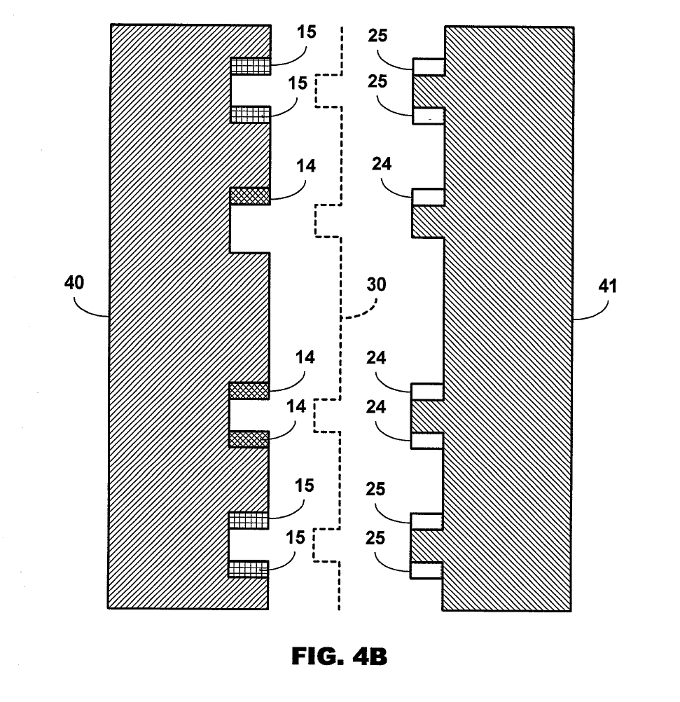

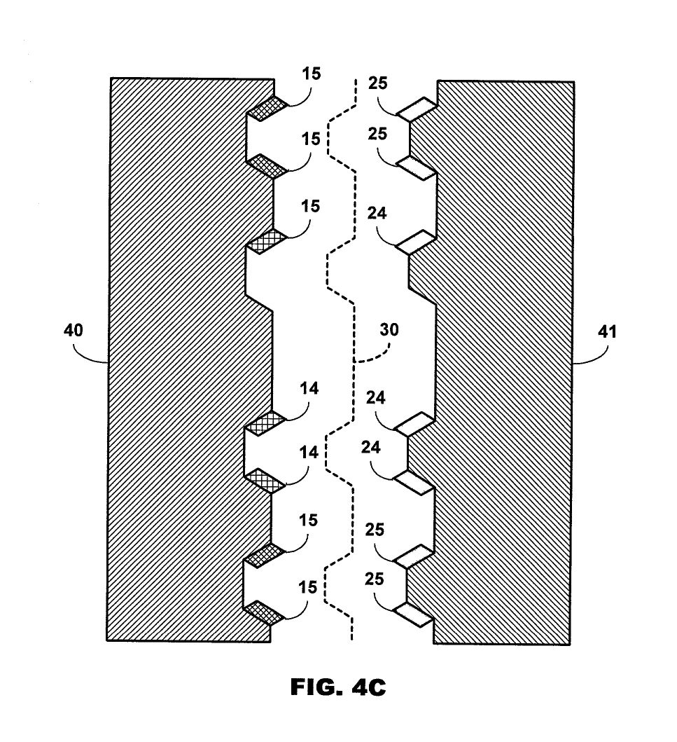

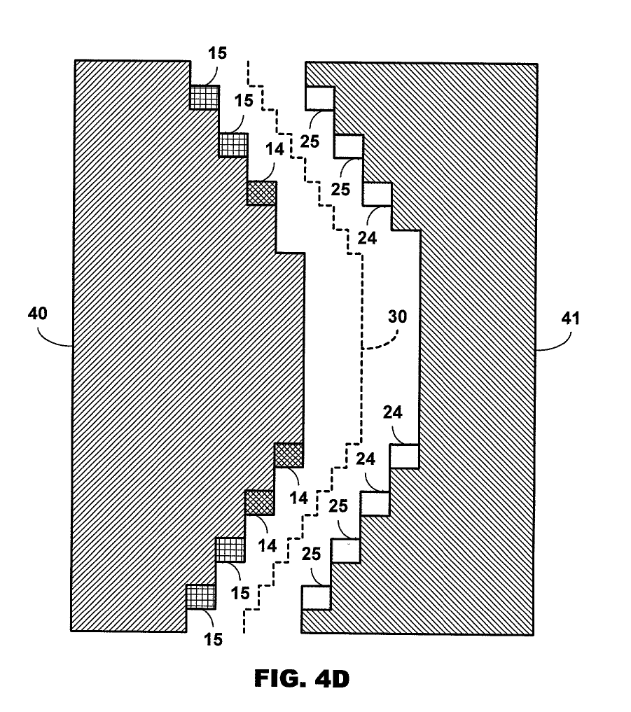

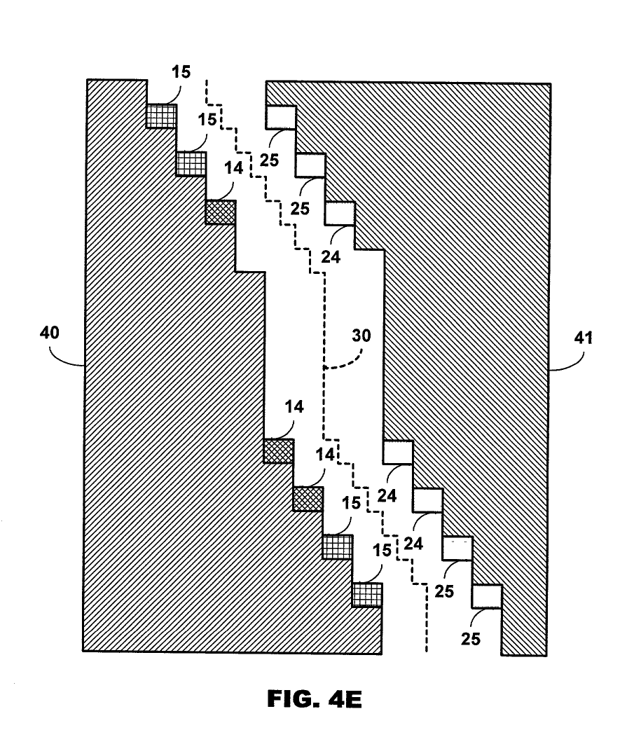

FIG. 4A illustrates a cross-sectional view relative to interface 30 of one configurational embodiment of substrate 40 and substrate 41 taken along a line I-I in FIG. 2A whereby interface 30 is corrugated.

FIG. 4B illustrates a cross-sectional view relative to interface 30 of a second configurational embodiment of substrate 40 and substrate 41 taken along a line I-I in FIG. 2A whereby interface 30 is corrugated.

FIG. 4C illustrates a cross-sectional view relative to interface 30 of a third configurational embodiment of substrate 40 and substrate 41 taken along a line I-I in FIG. 2A whereby interface 30 is corrugated.

FIG. 4D illustrates a cross-sectional view relative to interface 30 of a fourth configurational embodiment of substrate 40 and substrate 41 taken along a line I-I in FIG. 2A whereby interface 30 is corrugated.

FIG. 4E illustrates a cross-sectional view relative to interface 30 of a fifth configurational embodiment of substrate 40 and substrate 41 taken along a line I-I in FIG. 2A whereby interface 30 is corrugated.

FIG. 5 illustrates a functional equivalent of device 10 as shown in FIG. 1. Electric conductor 14 (FIG. 1) functions as a coil L1 when power source 11 provides an alternating electric signal in the form of an alternating current supply signal I_{SS1} flowing through electric conductor 14. In response thereto, electric conductor 14 generates a magnetic field generally shown by a dashed ellipse. The magnetic field traverses interface 30 whereby magnetic flux of the magnetic field cuts across electric conductor 24 (FIG. 1). In response thereto, electric conductor 24 functions as a coil L3 whereby an alternating electric signal in the form of an alternating current drive signal I_{DS1} flows through electric conductor 24 and load 21. As a result, power source 11 and load 21 are inductively coupled.

Electric conductor 15 (FIG. 1) functions as a coil L2 when power source 13 provides an alternating electric signal in the form of an alternating current supply signal I_{SS2} flowing through electric conductor 15. In response thereto, electric conductor 15 generates a magnetic field generally shown by a dashed ellipse. The magnetic field traverses interface 30 whereby magnetic flux of the magnetic field cuts across electric conductor 25 (FIG. 1). In response thereto, electric conductor 25 functions as a coil L4 whereby an alternating electric signal in the form of an alternating current drive signal I_{DS2} flows through electric conductor 25 and load 23. As a result, power source 13 and load 23 are inductively coupled.

Power source 11 applies an alternating electric signal in the form of an alternating voltage signal V_{SS1} between lead 14a and lead 14b of electric conductor 14, and an alternating voltage drive signal V_{DS1} is generated between lead 24a and lead 24b of electric conductor 24. Additionally, power source 13 applies an electric signal in the form of an alternating voltage signal V_{SS2} between lead 15a and lead 15b of electric conductor 15, and an alternating voltage drive signal V_{DS2} is generated between lead 25a and lead 25b of electric conductor 25. In response thereto, electric conductor 14 functions as a capacitive plate CP1 and electric conductor 24 functions as a capacitive plate CP3 whereby electric energy undulates between electric conductor 14 and electric conductor 24. Also, electric conductor 15 functions as a capacitive plate CP2 and electric conductor 25 functions as a capacitive plate CP4 whereby electric energy undulates between electric conductor 15 and electric conductor 25. As a result, power source 12 and load 22 are capacitively coupled whereby power source 12 is operable to provide an alternating electric signal in the form of an alternating current control signal I_{CS} to load 22.

Those skilled in the art will appreciate that there is no interaction between alternating current drive signal I_{DS1}, alternating current control signal IC_{CS}, and alternating current drive signal I_{DS2}. The inductive coupling of power source 11 and load 21, the capacitive coupling of power source 12 and load 22, and the inductive coupling of power source 13 and load 23 are each electrically isolated whereby each coupling can be optimized.

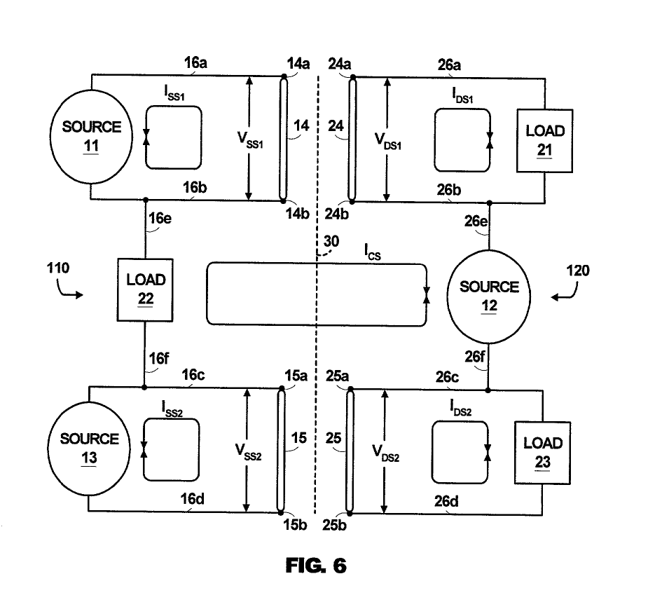

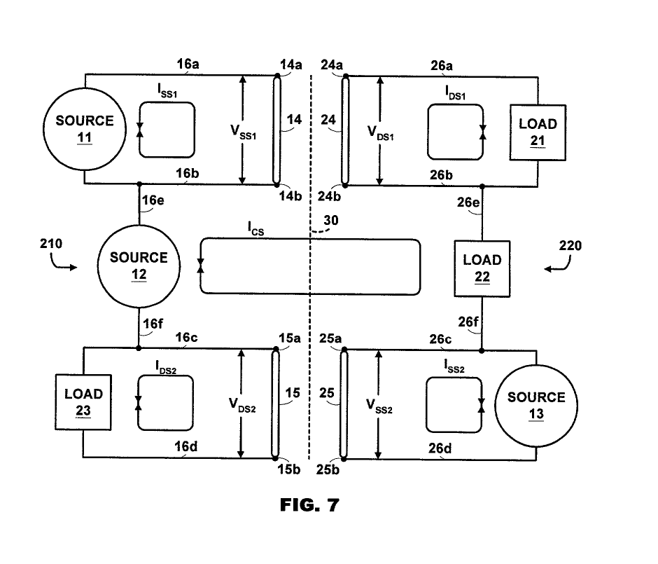

FIG. 6 illustrates a modified version 110 of source circuit 10 (FIG. 1) wherein circuit 110 includes load 22 in lieu of power source 12. FIG. 7 also illustrates a modified version 120 of load circuit 20 (FIG. 1) wherein circuit 120 includes power source 12 in lieu of load 22. As with circuit 10 and circuit 20, electric conductor 14 transfers magnetic energy and electric energy across interface 30 to electric conductor 24 when power source 11 provides alternating current supply signal I_{SS1} and alternating voltage supply signal V_{SS1} to electric conductor 14. Additionally, electric conductor 15 transfers magnetic energy and electric energy across interface 30 to electric conductor 25 when power source 13 provides alternating current supply signal I_{SS2} and alternating voltage supply signal V_{SS2} to electric conductor 15. Consequently, alternating current drive signal I_{DS1}, alternating voltage electric signal V_{SS1}, alternating current drive signal I_{DS2}, alternating voltage electric signal V_{SS2}, and alternating current control signal I_{CS} are provided as shown.

FIG. 7 illustrates a modified version 210 of source circuit 10 (FIG. 1) wherein circuit 210 includes load 23 in lieu of power source 13. FIG. 7 also illustrates a modified version 220 of load circuit 20 (FIG. 1) wherein circuit 220 includes power source 13 in lieu of load 23. As with circuit 10 and circuit 20, electric conductor 14 transfers magnetic energy and electric energy across interface 30 to electric conductor 24 when power source 11 provides alternating current supply signal I_{SS1} and alternating voltage supply signal V_{SS1} to electric conductor 14. Additionally, electric conductor 15 transfers magnetic energy and electric energy across interface 30 to electric conductor 25 when power source 13 provides alternating current supply signal I_{SS2} and alternating voltage supply signal V_{SS2} to electric conductor 15. Consequently, alternating current drive signal I_{DS1}, alternating voltage electric signal V_{SS1}, alternating current drive signal I_{DS2}, alternating voltage electric signal V_{SS2}, and alternating current control signal I_{CS} are provided as shown.

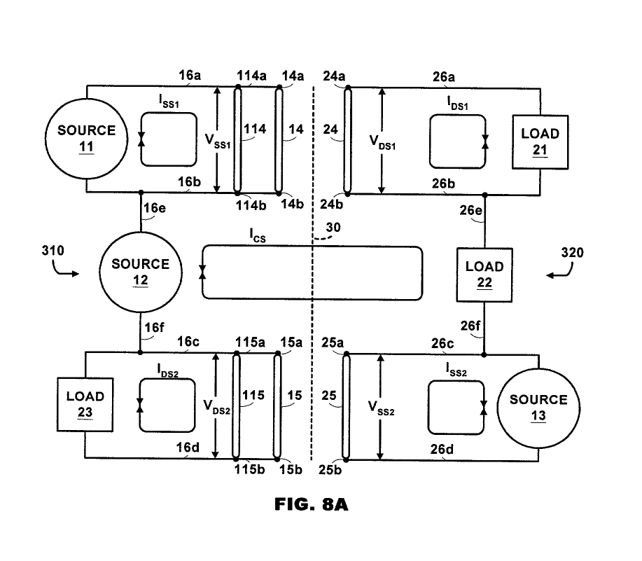

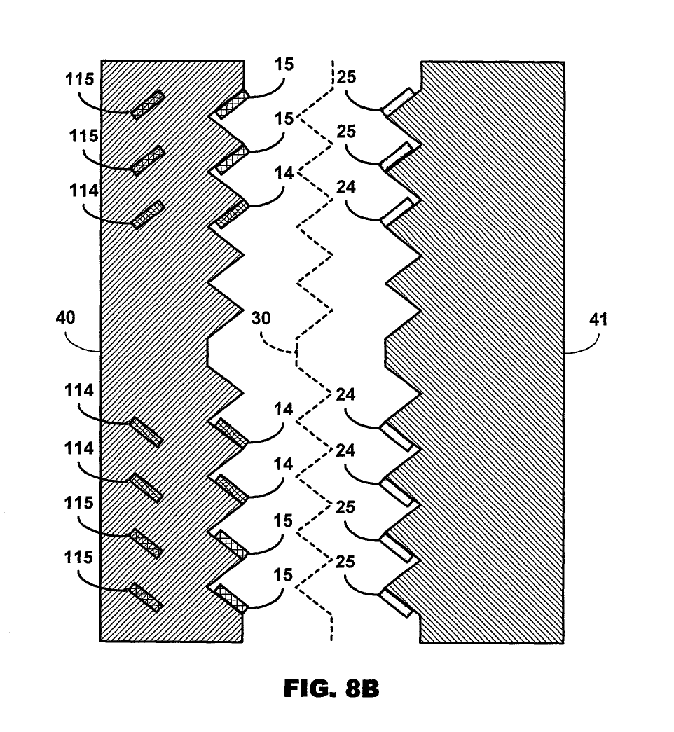

FIG. 8A illustrates a modified version 310 of source circuit 10 (FIG. 1) wherein circuit 310 further comprises an electric conductor 114 and an electric conductor 115. Electric conductor 114 has a lead 114a electrically coupled to power source 11 via electric conductor 16a. Electric conductor 114 further has a lead 114b electrically coupled to power source 11 via electric conductor 16b. Lead 114b is also electrically coupled to power source 12 via electric conductor 16b and electric conductor 16e. Electric conductor 115 has a lead 115b electrically coupled to power source 13 via electric conductor 16d. Electric conductor 115 further has a lead 115a electrically coupled to power source 13 via electric conductor 16d. Lead 115a is also electrically coupled to power source 12 via electric conductor 16c and electric conductor 16f.

Electric conductor 14 and electric conductor 114 collectively transfer magnetic energy across interface 30 to electric conductor 24 when power source 11 provides alternating current supply signal I_{SS1} and alternating voltage supply signal V_{SS1} to electric conductor 14 and electric conductor 114. Concurrently, electric conductor 14 transfers electric energy across interface 30 to electric conductor 24. Electric conductor 15 and electric conductor 115 collectively transfer magnetic energy across interface 30 to electric conductor 25 when power source 13 provides alternating current supply signal I_{SS2} and alternating voltage supply signal V_{SS2} to electric conductor 15 and electric conductor 115. Concurrently, electric conductor 15 transfers electric energy across interface 30 to electric conductor 25. Consequently, alternating current drive signal I_{DS1}, alternating voltage electric signal V_{SS1}, alternating current drive signal I_{DS2}, alternating voltage electric signal V_{SS2}, and alternating current control signal I_{CS} are provided as shown.

Conductor 114 and conductor 115 have spiral configurations such as the spiral configurations of conductor 14 and conductor 15 as shown in FIGS. 2A and 3A. For example, FIG. 8B illustrates a cross-sectional view relative to interface 30 of the FIG. 4A configurational embodiments of substrate 40 and substrate 41 wherein electric conductor 14 and electric conductor 114 are formed with substrate 40, and electric conductor 15 and electric conductor 115 are formed with substrate 41.

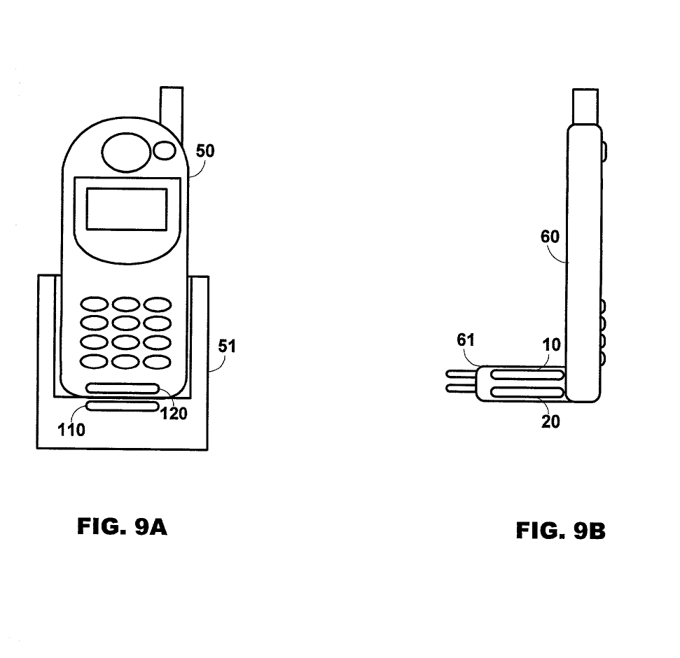

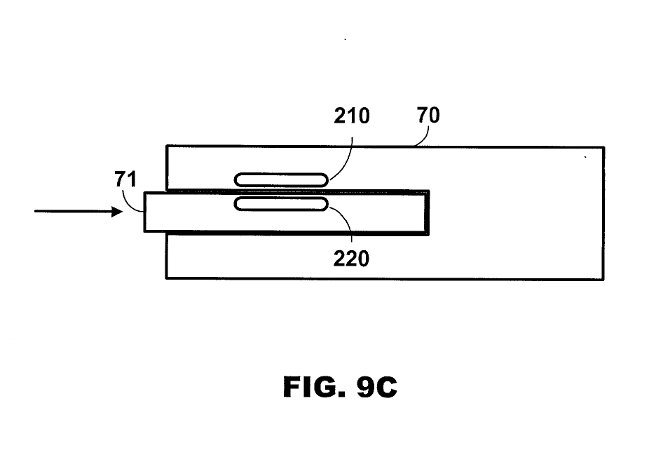

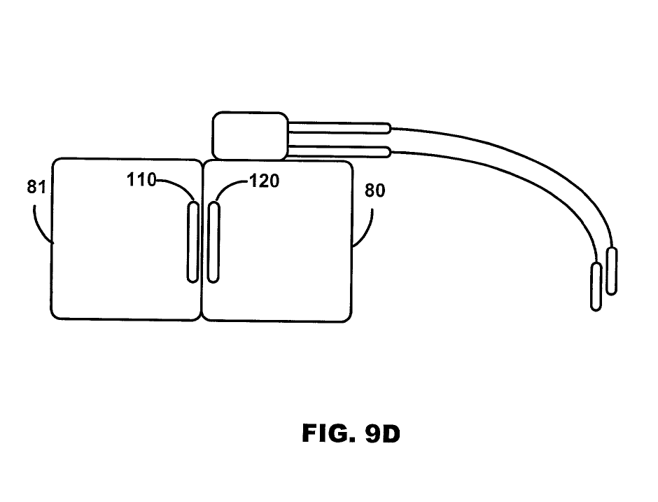

The employment of circuit 110 (FIG. 6) in a battery recharger 51 and of load circuit 120 (FIG. 6) in a portable phone 50 is illustrated in FIG. 9A. In one embodiment, power source 11 and power source 13 are utilized to recharge portable phone 50 via the generation of alternating current drive signal I_{DS1} and alternating current drive signal I_{DS2}, while power source 13 is utilized to provide alternating current control signal I_{CS} as an indication when portable phone 50 is fully recharged.

The employment of source circuit 10 (FIG. 1) and load circuit 20 (FIG. 1) within a rechargeable arm 61 of a portable phone 60 is illustrated in FIG. 9B. In one embodiment, power source 11 and power source 13 are utilized to recharge portable phone 60 via the generation of alternating current drive signal I_{DS1} and alternating current drive signal I_{DS2}, while power source 13 is utilized to provide alternating current control signal I_{CS} as an indication when portable phone 60 is fully recharged.

The employment of circuit 210 (FIG. 7) within a security reader 70 and circuit 220 (FIG. 7) within a security badge 71 is illustrated in FIG. 9C. In one embodiment, power source 11 and power source 13 are utilized to provide a handshake between security reader 70 and security badge 71 via the generation of alternating current drive signal I_{DS1} and alternating current drive signal I_{DS2}, while power source 13 is utilized to provide alternating current control signal I_{CS} as security information relating to security badge 71 to security reader 70.

The employment of circuit 110 (FIG. 6) in pacemaker 80 and of load circuit 120 (FIG. 6) in a battery recharger 81 is illustrated in FIG. 9D. In one embodiment, power source 11 and power source 13 are utilized to recharge pacemaker 80 via the generation of alternating current drive signal I_{DS1} and alternating current drive signal I_{DS2}, while power source 13 is utilized to provide alternating current control signal I_{CS} as an indication are non-intrusive coupling of pacemaker 80 and battery recharger 81.

FIGS. 9A-9D are exemplary utilization of the inductive coupling and capacitive coupling principles of the present invention. Those having ordinary skill in the art will appreciate additional utilizations of the inductive coupling and capacitive coupling principles of the present invention.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A dual energy coupling device, comprising:
a first electric conductor; and
a second electric conductor,
wherein said first electric conductor is operable to transfer a magnetic energy and an electric energy across an interface to said second electric conductor in response to a reception of an alternating electric signal.

2. The dual energy coupling device of claim 1, wherein said first electric conductor has a spiral configuration and said second electric conductor has a spiral configuration.

3. The dual energy coupling device of claim 1, wherein said first electric conductor and said second electric conductor are symmetrical relative to the interface.

4. The dual energy coupling device of claim 1, further comprising:
a first substrate including a corrugated surface having said first electric conductor formed thereon; and
a second substrate includes a corrugated surface having said second electric conductor formed thereon.

5. A dual energy coupling device, comprising:
a first power source operable to provide a first electric signal;
a first electric conductor in electrical communication with said first power source to thereby receive the first electric signal when said first power source is providing the first electric signal; and
a second electric conductor,
wherein said first electric conductor is operable to transfer a first magnetic energy and a first electric energy across an interface to said second electric conductor in response to a reception of the first electric signal.

6. The dual energy coupling device of claim 5, further comprising:
a first load in electrical communication with said second electric conductor,
wherein a current drive signal flows through said second electric conductor and said first load in response to a reception of said first magnetic energy by said second electric conductor.

7. The dual energy coupling device of claim 5, further comprising:
a second power source operable to provide a second electric signal;
a third electric conductor in electrical communication with said second power source to thereby receive the second electric signal when said second power source is providing the second electric signal; and
a fourth electric conductor,
wherein said third electric conductor is operable to provide a second magnetic energy and a second electric energy across the interface to said fourth electric conductor in response to a reception of the second electric signal.

8. The dual energy coupling device of claim 7, further comprising:
a second load in electrical communication with said fourth electric conductor,
wherein a current drive signal flows through said fourth electric conductor and said second load in response to a reception of said second magnetic energy by said fourth electric conductor.

9. The dual energy coupling device of claim 5, further comprising:
a power source operable to provide a current control signal; and
a third load operable to be in electrical communication with said power source in response to a reception of said first electric energy by said second electric conductor and a reception of said second electric energy by said fourth electric conductor to thereby receive the current control signal when said power source is providing the current control signal.

10. The dual energy coupling device of claim 5, wherein said first electric conductor has a spiral configuration and said second electric conductor has a spiral configuration.

11. The dual energy coupling device of claim 5, wherein said first electric conductor and said second electric conductor are symmetrical relative to the interface.

12. The dual energy coupling device of claim 5, further comprising:
a first substrate including a corrugated surface having said first electric conductor formed thereon; and
a second substrate includes a corrugated surface having said second electric conductor formed thereon.

13. A dual energy coupling device, comprising:
a first electric conductor having a spiral configuration; and
a second electric conductor having a spiral configuration,
wherein said first electric conductor and said second electric conductor are symmetrical relative to an interface.

14. A dual energy coupling device, comprising:
a first power source operable to provide a first electric signal;
a first load;
a means for inductively coupling said first power source and said first load when said first power source is providing the first electric signal.

15. The dual energy coupling device of 14, further comprising:
a second power source operable to provide a second electric signal;
a second load; and
a means for inductively coupling said second power source and said second load when said second power source is providing the second electric signal.

16. The dual energy coupling device of 15, further comprising:
a power source;
a third load; and
a means for capacitively coupling said power source and said third load when said first power source and said first load are inductively coupled and when said second power source and said second load are inductively coupled.

17. A dual energy coupling device, comprising:
a first power source operable to provide a first electric signal;
a second power source operable to provide a second electric signal;
a power source;
a load; and
a means for capacitively coupling said power source and said third load when said first power source is providing the first electric signal and said second power source is providing the second electric signal.
